(19) United States
(12) Patent Application Publication
(10) Pub. No.: US 2025/0135659 A1
(43) Pub. Date: May 1, 2025

(54) Self-Sealing Suction Device

(71) Applicant: The Boeing Company, Arlington, VA (US)

(72) Inventor: Phillip Tran, Somerville, MA (US)

(21) Appl. No.: 18/498,207

(22) Filed: Oct. 31, 2023

(51) Int. Cl. B25J 15/06; B25B 11/00; B64D 1/22

(52) U.S. Cl. CPC B25J 15/0658; B64D 1/22; B25B 11/005

(57) ABSTRACT

A self-sealing suction device system is provided. The system comprises a suction device, a pressure sensor in communication with the suction device, a vacuum supply in communication with the suction device, and a solenoid valve in communication with the suction device and the vacuum supply. A controller is programmed to turn on the vacuum supply responsive to the pressure sensor detecting air pressure within the suction device above a specified threshold. The controller turns off the vacuum supply responsive to the pressure sensor detecting a specified level of negative pressure within the suction device, wherein the solenoid valve maintains the negative pressure within the suction device. The controller maneuvers the solenoid valve to equilibrate the suction device with atmospheric pressure to release the object upon completion of a task.

### BACKGROUND INFORMATION

### Technical Field

The present disclosure relates generally to suction devices for manipulating objects, and more specifically to self-sealing suction devices using active vacuum control.

### Background

Suction devices such as suction cups are used for manipulating and moving objects in various types of applications such as manufacturing. Self-sealing suction cups typically employ complex mechanical designs that facilitate passive opening and closing of a pneumatic inlet to the suction cup. A passive plug seals a pneumatic inlet to the suction cup. When force is applied to the suction cup, the plug is mechanically displaced, thereby opening the inlet and generating suction in the suction cup.

This approach requires various components to move in concert, which can be difficult to implement on a small scale. Furthermore, these components are generally built into the body of the suction cup itself, increasing fabrication complexity and the risks of mechanical failure.

### SUMMARY

An illustrative embodiment provides a self-sealing suction device system. The system comprises a suction device, a pressure sensor in communication with the suction device, a vacuum supply in communication with the suction device, and a solenoid valve in communication with the suction device and the vacuum supply. A controller is programmed to turn on the vacuum supply responsive to the pressure sensor detecting air pressure within the suction device above a specified threshold. The controller turns off the vacuum supply responsive to the pressure sensor detecting a specified level of negative pressure within the suction device, wherein the solenoid valve maintains the negative pressure within the suction device. The controller maneuvers the solenoid valve to equilibrate the suction device with atmospheric pressure to release the object upon completion of a task.

Another illustrative embodiment provides a self-sealing suction device system. The system comprises a suction device and a pressure sensor connected to the suction device. The pressure sensor is configured to detect a seal formed between the suction device and a surface that results in an increase of air pressure in the suction device above a specified threshold. A vacuum supply is connected to the suction device. The vacuum supply turns on when the pressure detects the seal formed between the suction device and surface and turns off when negative pressure within the self-sealing suction device system reaches a specified level. A solenoid valve connected to the suction device and vacuum supply isolates the self-sealing suction device system from atmospheric pressure to allow the suction device to form the seal with the surface and allow the vacuum supply to generate negative pressure. The solenoid valve maintains negative pressure after the vacuum supply turns off and then vents to atmospheric pressure to release the seal between the suction device and surface.

Another embodiment provides a method of manipulating an object with a self-sealing vacuum device system. The method comprises detecting, by a pressure sensor, air pressure within a suction device above a specified threshold resulting from contact between the suction device and the object. A controller turns on a vacuum supply in communication with the suction device responsive to detecting the air pressure within the suction device above the specified threshold. The controller turns off the vacuum supply responsive to detecting a specified level of negative pressure with the suction device, wherein a solenoid valve maintains the negative pressure within the suction device. The controller vents the suction device to atmospheric pressure via the solenoid valve to release the object after completing a task.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a self-sealing suction device system in accordance with an illustrative embodiment;

FIG. 2A depicts a self-sealing suction device system in an idle state in accordance with an illustrative embodiment;

FIG. 2B depicts a self-sealing suction device system maneuvered into contact with a payload in accordance with an illustrative embodiment;

FIG. 2C depicts a self-sealing suction device system with an activated vacuum supply in accordance with an illustrative embodiment;

FIG. 2D depicts a self-sealing suction device system when the vacuum supply is switched off after achieving a specified level of negative pressure in accordance with an illustrative embodiment;

FIG. 2E depicts a self-sealing suction device system releasing suction from the payload in accordance with an illustrative embodiment;

FIGS. 3A-3C depicts an example of determining sufficient contact with a target object according to suction device deformation in accordance with an illustrative embodiment;

FIGS. 4A-4G depict an example operation of a self-sealing suction device system on a robot arm in accordance with an illustrative embodiment;

FIGS. 5A-5G depict an example operation of a self-sealing suction device system on a UAV in accordance with an illustrative embodiment; and

FIG. 6 is an illustration of a block diagram of a data processing system in accordance with an illustrative embodiment.

### DETAILED DESCRIPTION

The illustrative embodiments recognize and take into account that the state of the art in self-sealing suction cups typically employs complex mechanical designs that facilitate passive opening and closing of a pneumatic inlet to the suction cup. A passive plug seals a pneumatic inlet to the suction cup. When force is applied to the suction cup, the plug is mechanically displaced, opening the inlet and generating suction.

The illustrative embodiments recognize and take into account that this approach requires various components to move in concert, which can be difficult to implement on a small scale. The illustrative embodiments also recognize and take into account that these components are generally built into the body of the suction cup itself, increasing fabrication complexity and the risks of mechanical failure.

The illustrative embodiments also recognize and take into account that current self-sealing suction cup designs also employ vacuum systems that are continually on. In addition to increasing the power requirements of such systems, continuous suction from the vacuum system increases the risk of accidentally picking up the wrong object as well as increasing the generation of static electricity, which can be detrimental in applications such as manufacturing.

The illustrative embodiments provide a system for self-sealing suction devices for manipulating objects. The system utilizes flexible suctions devices such as suction cups and one or more pressure sensors to engage a vacuum source only when sufficient contact has been established with the target object.

This disclosure presents the concept of a self-sealing suction device system for object manipulation and interaction. The self-sealing suction device system contains one or more suction devices such as, e.g., suction cups, that can be placed in arrays in series or parallel, coupled with one or more pressure sensors at the suction devices and the pneumatic supply line(s), check valves, solenoid valves, a vacuum supply, pneumatic tubing, a microcontroller, and associated circuitry. The suction devices may include any device with a hollow center in which a partial vacuum (negative fluid pressure) can be produced to adhere to a surface. The suction devices can be embedded within manipulators or stationary structures, or used without supports. Following verification of successful contact with a payload, the check valves and solenoid valves engage to preserve vacuum pressure in the suction device while shutting off the vacuum supply to conserve energy expenditure.

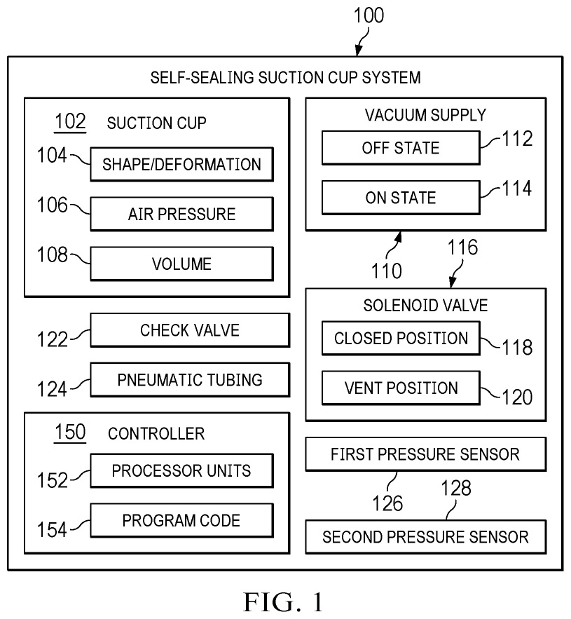

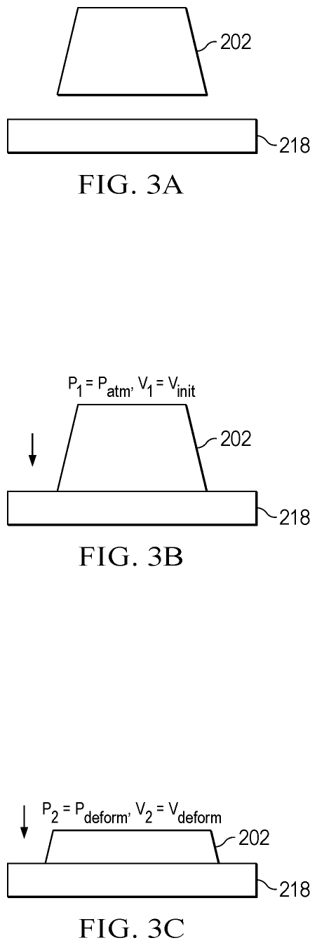

With reference now to FIG. 1, a block diagram of a self-sealing suction device system is depicted in accordance with an illustrative embodiment. Self-sealing suction device system 100 comprises a suction device 102 that has a defined shape 104 that can deform in response to contact with an object surface. Suction device 102 also has an internal air pressure 106 and volume 108 that changes in response to deformation resulting from contact with an object (see FIGS. 3A-3C). Suction device 102 might be, for example, a suction cup.

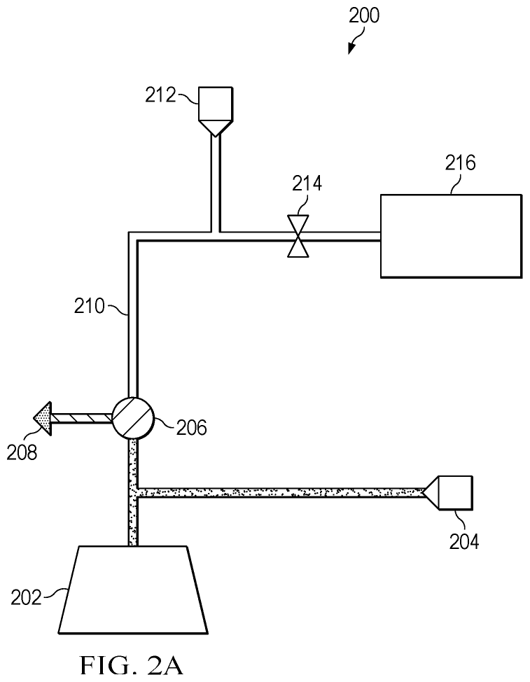

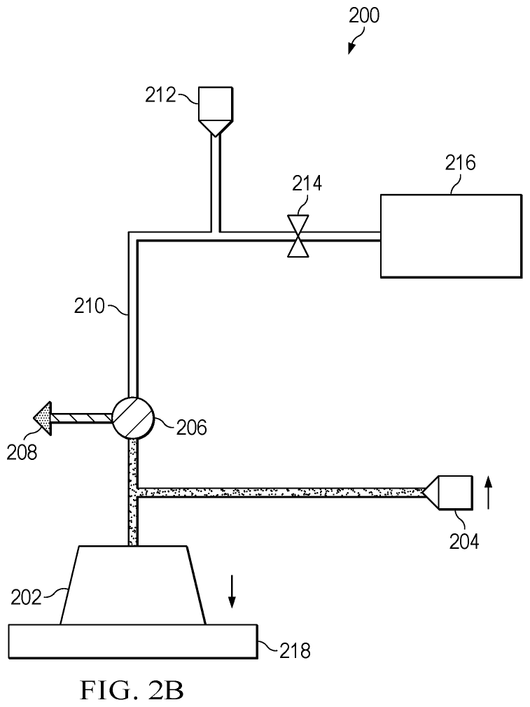

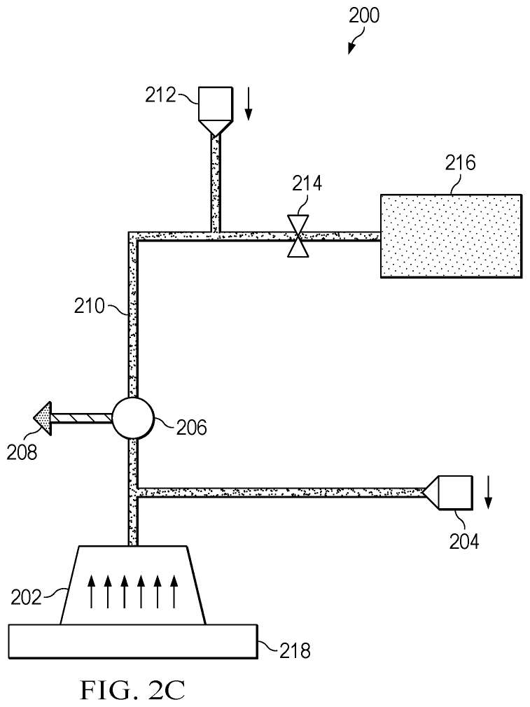

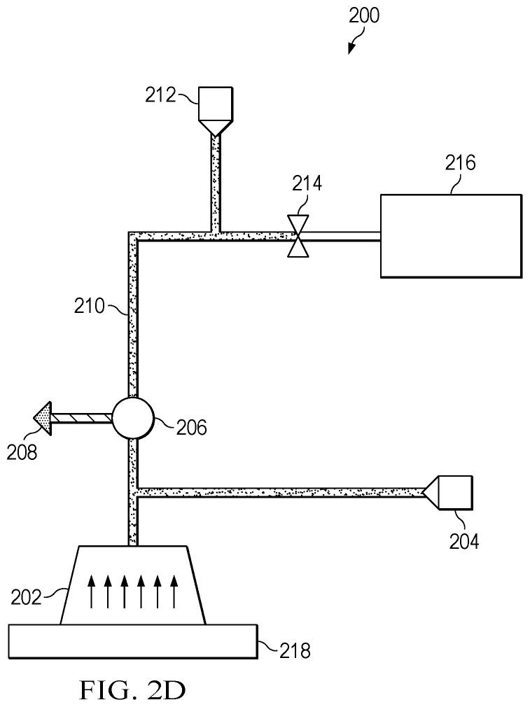

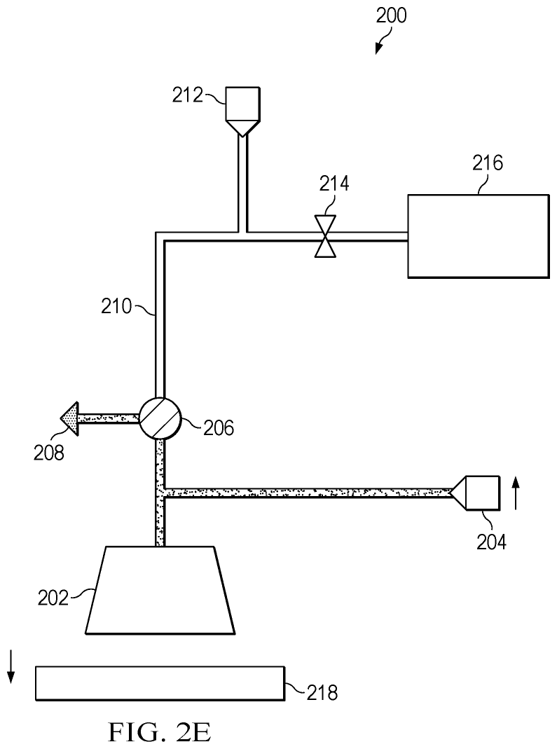

Suction power is provided to the suction device 102 by a vacuum supply 110 that can generate negative pressure through pneumatic tubing 124. Vacuum supply 110 can alternate between an off state 112 and on state 114 as needed and does not have to run continuously. Vacuum supply 110 can be controlled by controller 150 in response to signals generated by a first pressure sensor 126 in response to changes in the air pressure 106 of suction device 102 (see FIGS. 2A-2E).

Negative pressure can be maintained in self-sealing suction device system 100 by a solenoid valve 116. Solenoid valve 116 can alternate between a first closed position 118 and a second vent position 120. In the closed position 118 the solenoid valve 116 isolates the suction device 102 and pneumatic tubing 124, connecting the vacuum supply 110 to the suction device from atmosphere. As such, when specified desired adequate negative pressure is achieved within self-sealing suction device system 100, the vacuum supply 110 can be turned to the off state 112 without losing suction power. When suction is no longer required, the solenoid valve 116 is switched to vent position 120, which allows the self-sealing suction device system 100 to equilibrate with atmospheric pressure.

Solenoid valve 116 may be supplemented by a check valve 122 in the pneumatic tubing 124. Check valve 122 is a one-way valve that prevents atmospheric air from entering the pneumatic tubing 124 when the vacuum supply is switched off.

A second pressure sensor 128 might also be present and, if so, be used to monitor pressure in the pneumatic tubing 124. The second pressure sensor 128 can determine whether adequate negative pressure is being generated in self-sealing suction device system 100. Inadequate negative pressure might be the result of a malfunction of the vacuum supply 110 and/or a leak somewhere in the system such as the pneumatic tubing 124, solenoid valve 116, or check valve 122.

Controller 150 is configured or programmed to control the operation of the vacuum supply 110, solenoid valve 116, first pressure sensor 126, and second pressure sensor 128. Controller 150 is a physical hardware system and includes one or more data processing systems. When more than one data processing system is present in controller 150, those data processing systems are in communication with each other using a communications medium. The communications medium can be a network. The data processing systems can be selected from at least one of a computer, a server computer, a tablet computer, or some other suitable data processing system.

As depicted, controller 150 includes a number of processor units 152 that are capable of executing program code 154 implementing processes in the illustrative examples. As used herein a processor unit in the number of processor units 152 is a hardware device and is comprised of hardware circuits such as those on an integrated circuit that respond and process instructions and program code that operate a computer. When a number of processor units 152 execute program code 154 for a process, the number of processor units 152 is one or more processor units that can be on the same computer or on different computers. In other words, the process can be distributed between processor units on the same or different computers in a controller. Further, the number of processor units 152 can be of the same type or different type of processor units.

FIG. 2A depicts a self-sealing suction device system in an idle state in accordance with an illustrative embodiment. Self-sealing suction device system 200 is an example implementation of self-sealing suction device system 100 shown in FIG. 1. In the example shown in FIG. 2A, self-sealing suction device system 200 comprises two pressure sensors 204, 212. However, the scope and functionality of the present invention can encompass configurations that included only one pressure sensor, which generally would be pressure sensor 204 that is positioned to detect pressure within the suction device 202.

In the idle state, the vacuum supply 216 is off, and the solenoid valve 206 is shut. In the idle state the suction device 202, pressure sensor 204, and solenoid valve 206 are in communication in a closed pneumatic circuit. Solenoid valve 206 might be a 2/1 valve comprising two inlets and one outlet, wherein one inlet is connected to the vacuum supply 216, the other inlet is a vent inlet 208 to atmosphere (i.e., no connection), and the outlet is connected to the suction device 202.

FIG. 2B depicts a self-sealing suction device system maneuvered into contact with a payload in accordance with an illustrative embodiment.

When the suction device 202 makes contact with the surface of an object 218 that constitutes the target payload, the suction device undergoes deformation. Once the suction device 202 establishes sufficient contact with the object 218, and a seal sufficient to prevent the escape of air is formed between the surface of the object 218 and the suction device 202, pressure sensor 204 detects an increase in air pressure resulting from force exerted by the suction device 202 against the object 218 (See FIGS. 3A-3C).

FIG. 2C depicts a self-sealing suction device system with an activated vacuum supply in accordance with an illustrative embodiment.

In response to the increased air pressure detected by pressure sensor 204, self-sealing suction device system 200 activates vacuum supply 216. The solenoid valve 206 opens the inlet connected to the vacuum supply 216, thereby placing the vacuum supply 216 in communication with the pneumatic circuit of the suction device 202 and pressure sensor 204 via pneumatic tubing 210. Vacuum supply 216 begins to generate negative pressure within the suction device 202, in turn generating suction force on the object 218.

If present, the pressure sensor 212 nearest the vacuum supply helps ensure that the vacuum flows properly through pneumatic tubing 210. Pressure sensor 204 monitors the negative pressure in the suction device 202 to determine when the negative pressure reaches a specified threshold.

FIG. 2D depicts a self-sealing suction device system when the vacuum supply is switched off after achieving a specified level of negative pressure in accordance with an illustrative embodiment.

When the pressure sensor 204 detects that the negative pressure has reached the specified level, the vacuum supply 216 is switched off. The solenoid valve 206 and check valve 214 ensure that the negative pressure in the suction device 202 does not equilibrate to atmospheric pressure when the vacuum supply 216 is switched off, thereby preserving the strength of the suction hold of the suction device 202 on the object 218. The check valve 214 prevents backflow of positive air pressure into the self-sealing suction device system 200 when the vacuum supply 216 is turned off.

FIG. 2E depicts a self-sealing suction device system having released its suction from the payload in accordance with an illustrative embodiment.

Once the object manipulation has been completed and it is desired for the object 218 to be released from the suction device 202, the solenoid valve 206 opens the vent inlet 208, allowing the suction device 202 to achieve air pressure equilibrium with the atmosphere, thereby releasing the object 218 from the suction device. The self-sealing suction device system 200 can then be reengaged in subsequent actions as desired.

The ability to turn the vacuum supply 216 on and off at will to generate intermittent vacuum suction when needed provides several advantages of self-sealing suction device system 200 over prior designs. The ability to turn off the vacuum supply 216 when not needed and use the solenoid valve 206 and check valve 214 to maintain negative pressure reduces the power required to run the self-sealing suction device system 200 compared to continuous-vacuum suction cup systems, as well as reduces “wear and tear” on the vacuum supply 216 compared to a continuous vacuum.

The ability to turn the vacuum supply 216 on and off to generate intermittent vacuum suction also reduces the risk of inadvertently picking up the wrong object compared to continuous, and makes it so uninterrupted suction is not required, providing the aforementioned power savings but also beneficially reducing the potential for build-up of static electricity.

FIGS. 3A-3C depict an example of determining sufficient contact with a target object according to suction device deformation in accordance with an illustrative embodiment. The fundamental equation used by the illustrative embodiments is:

$${P}_{1} {V}_{1} = {P}_{2} {V}_{2} \qquad Eq . ( 1 )$$

where P is air pressure and V is volume.

FIG. 3A depicts the suction device 202 positioned over the target object 218 before contact is made. When the suction device 202 first contacts the target object 218 as shown in FIG. 3B, the suction device has the following properties:

$${P}_{1} = {P}_{atm} , {V}_{1} = {V}_{init}$$

where Pₐₜₘ is atmospheric air pressure, and Vᵢₙᵢₜ is the initial volume of the suction device 202.

Increasing contact force between the suction device 202 and the target object 218 results in deformation of the suction device as shown in FIG. 3C, thereby changing the suction device's volume characterized as:

$${V}_{2} = {V}_{deform}$$

where V_{deform}<Vᵢₙᵢₜ.

Referring back to equation (1), the change in suction device volume causes a concomitant change in air pressure:

$${P}_{2} = {P}_{deform}$$

where P_{deform}>Pₐₜₘ

This relationship allows the self-sealing suction device system to detect, via the pressure sensor 204, when sufficient contact has been established with the target object 218 to activate the vacuum supply 216.

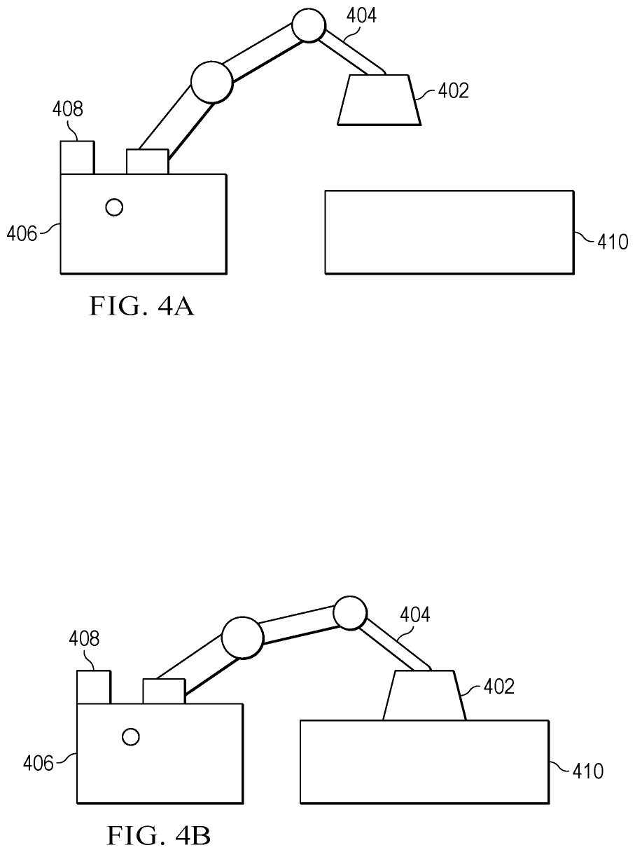

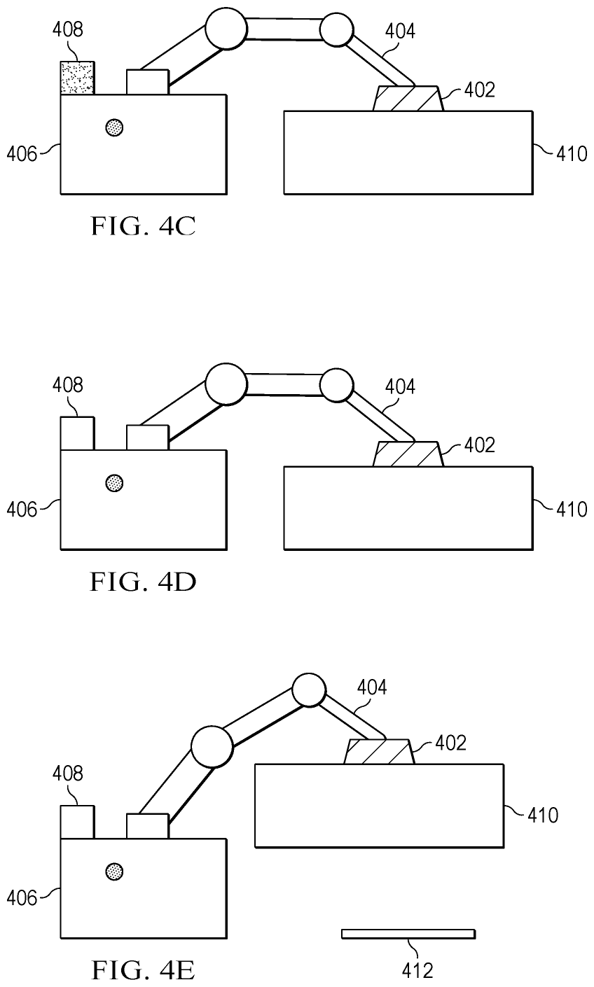

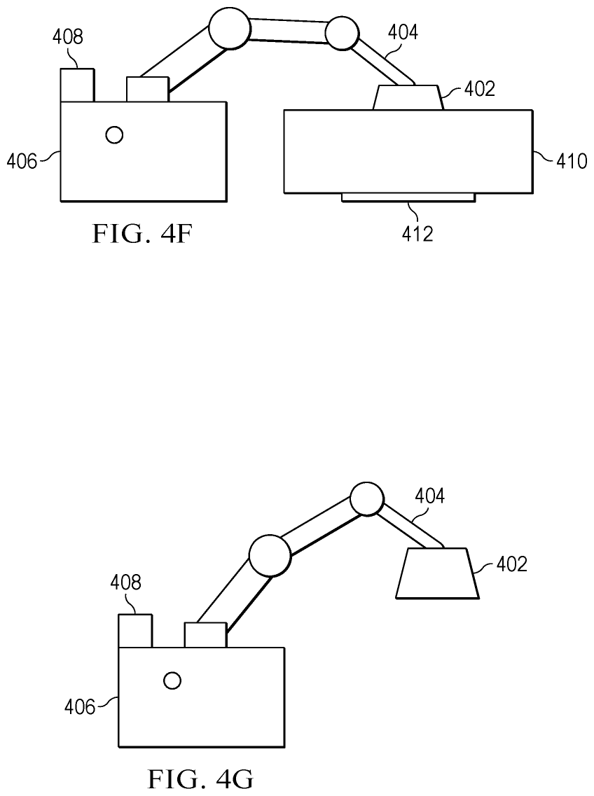

FIGS. 4A-4C depict an example operation of a self-sealing suction device system on a robot arm in accordance with an illustrative embodiment. The example shown in FIGS. 4A-4G can be implemented with self-sealing suction device system 200 shown in FIGS. 2A-2E.

In FIG. 4A, a suction device 402 is mounted on a robot arm 404 connected to a self-sealing system 406. As the robot arm 404 approaches the object 410, the vacuum supply 408 is off.

In FIG. 4B the robot arm 404 contacts the object 410 with the suction device 402. In response to increased air pressure from deformation of the suction device, the controller (e.g., controller 150) activates the vacuum supply 408 and self-sealing system 406, as shown in FIG. 4C.

Once a predefined desired level of negative pressure is achieved, the vacuum supply 408 is switched off, as shown in FIG. 4D, and the robot arm 404 lifts the object 410 and moves it toward a target area 412, as shown in FIG. 4E.

In FIG. 4F, the robot arm 404 maneuvers the object 410 onto the target area 412. The self-sealing system 406 then switches off, equilibrating with atmospheric air pressure to release the object 410. In FIG. 4G, the robot arm 404 repositions to ready itself to perform the next object manipulation task.

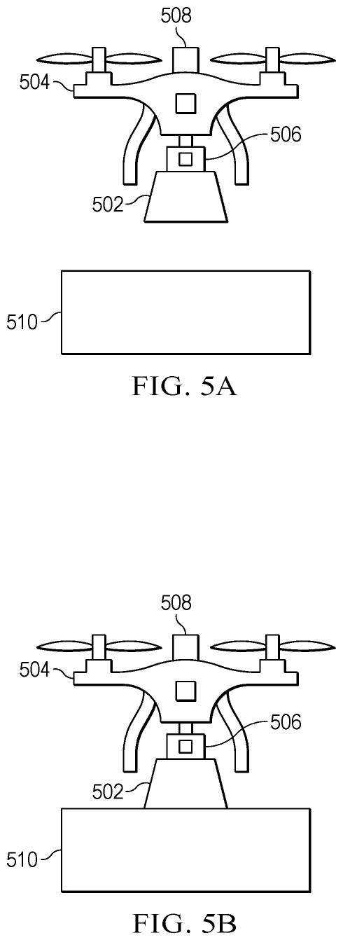

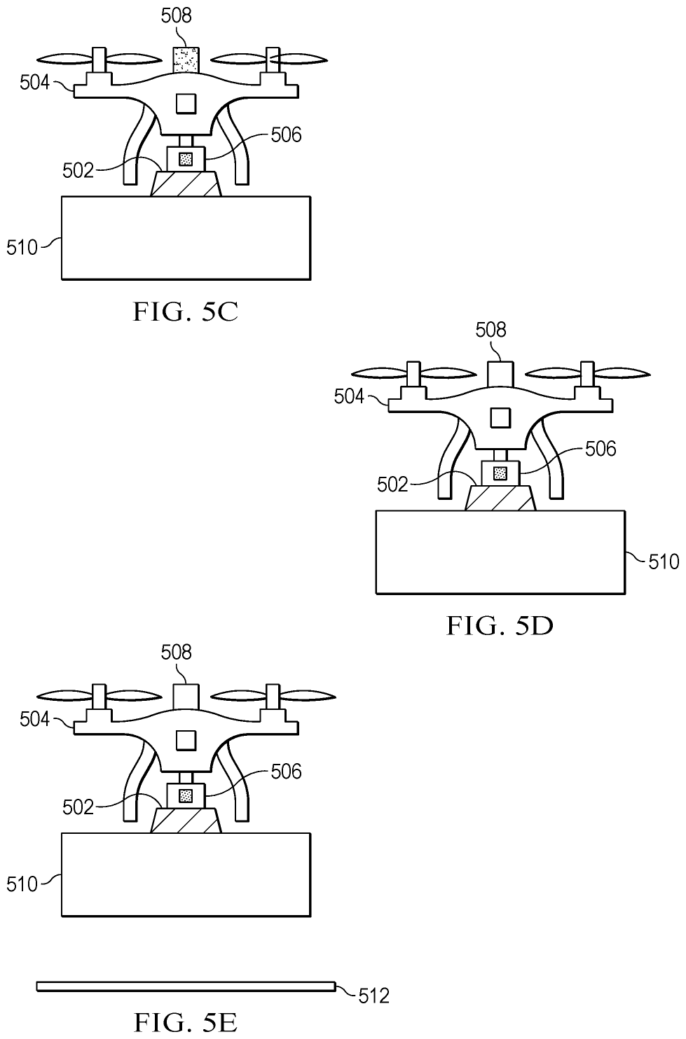

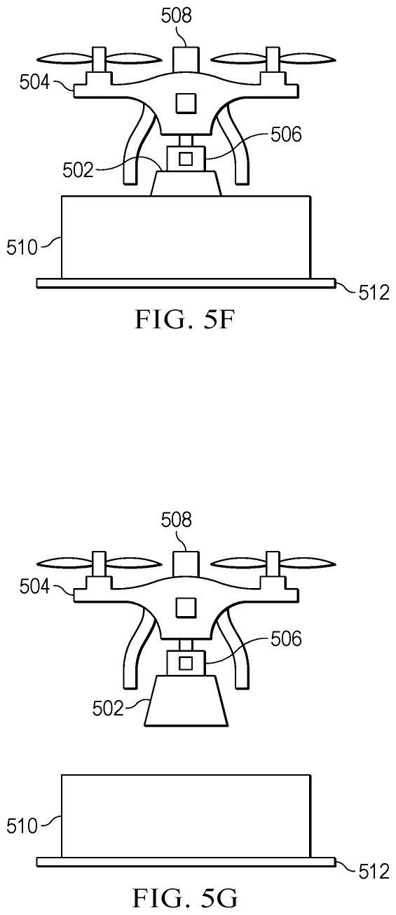

FIGS. 5A-5G depict an example operation of a self-sealing suction device system on an unmanned aerial vehicle (UAV) in accordance with an illustrative embodiment. Examples of UAVs include drones, unmanned aerial systems (UAS), remotely piloted aircraft (RPA), unmanned aircraft systems (UAS), fixed-wing UAVs, single-rotor and multi-rotor UAVs, and hybrid UAVs (mixture of fixed wing and rotor). The example shown in FIGS. 5A-5G can be implemented with self-sealing suction device system 200 shown in FIGS. 2A-2E mounted on a drone.

In FIG. 5A, a suction device 502 is connected to a self-sealing system 506 mounted on a drone 504. As the drone 504 approaches the object 510, the vacuum supply 508 is off.

In FIG. 5B the drone 504 contacts the object 510 with the suction device 502. In response to increased air pressure from deformation of the suction device, the drone 504 activates the vacuum supply 508 and self-sealing system 506, as shown in FIG. 5C.

Once a predefined desired level of negative pressure is achieved, the vacuum supply 508 is switched off, as shown in FIG. 5D, and the drone 504 lifts the object 510 and moves it toward a target area 512, as shown in FIG. 5E.

In FIG. 5F, the drone 504 maneuvers the object 510 onto the target area 512. The self-sealing system 506 then switches off, equilibrating with atmospheric air pressure to release the object 510. In FIG. 5G, the drone 504 lifts off to ready itself to perform the next object manipulation task.

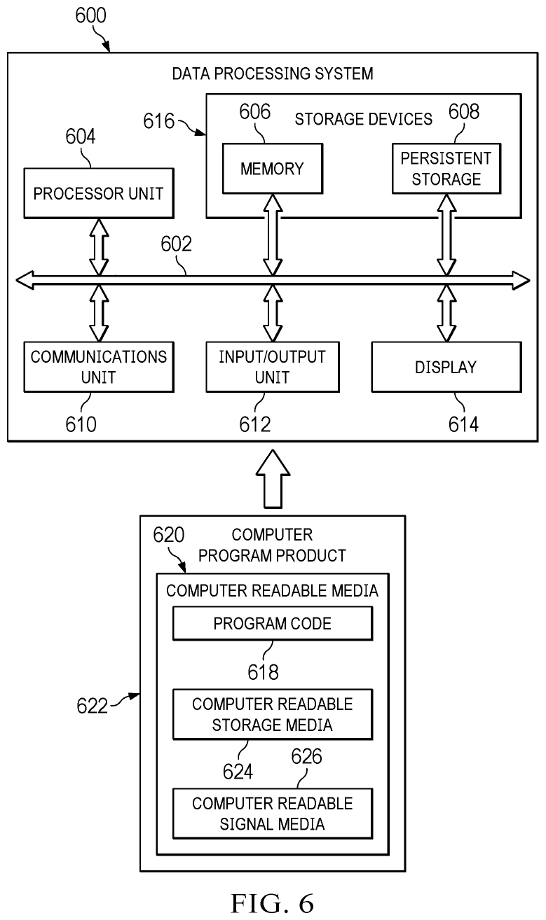

Turning now to FIG. 6, an illustration of a block diagram of a data processing system is depicted in accordance with an illustrative embodiment. Data processing system 600 may be used to implement controller 150 in FIG. 1. In this illustrative example, data processing system 600 includes communications framework 602, which provides communications between processor unit 604, memory 606, persistent storage 608, communications unit 610, input/output (I/O) unit 612, and display 614. In this example, communications framework 602 takes the form of a bus system.

Processor unit 604 serves to execute instructions for software that may be loaded into memory 606. Processor unit 604 may be a number of processors, a multi-processor core, or some other type of processor, depending on the particular implementation. In an embodiment, processor unit 604 comprises one or more conventional general-purpose central processing units (CPUs). In an alternate embodiment, processor unit 604 comprises one or more graphical processing units (GPUS).

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer-readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608. Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer-usable program code, or computer-readable program code that may be read and executed by a processor in processor unit 604. The program code in the different embodiments may be embodied on different physical or computer-readable storage media, such as memory 606 or persistent storage 608.

Program code 618 is located in a functional form on computer-readable media 620 that is selectively removable and may be loaded onto or transferred to data processing system 600 for execution by processor unit 604. Program code 618 and computer-readable media 620 form computer program product 622 in these illustrative examples. In one example, computer-readable media 620 may be computer-readable storage media 624 or computer-readable signal media 626.

In these illustrative examples, computer-readable storage media 624 is a physical or tangible storage device used to store program code 618 rather than a medium that propagates or transmits program code 618. Computer readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 618 may be transferred to data processing system 600 using computer-readable signal media 626. Computer-readable signal media 626 may be, for example, a propagated data signal containing program code 618. For example, computer-readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A self-sealing suction device system, comprising:
a suction device;
a pressure sensor in communication with the suction device;
a vacuum supply in communication with the suction device;
a solenoid valve in communication with the suction device and the vacuum supply; and
a controller programmed to:
turn on the vacuum supply responsive to the pressure sensor detecting air pressure within the suction device above a specified threshold;
turn off the vacuum supply responsive to the pressure sensor detecting a specified level of negative pressure within the suction device, wherein the solenoid valve maintains the negative pressure within the suction device; and
maneuver the solenoid valve to equilibrate the suction device with atmospheric pressure.

2. The self-sealing suction device system of claim 1, further comprising a second pressure sensor that monitors for negative pressure flow though the self-sealing suction device system generated by the vacuum supply.

3. The self-sealing suction device system of claim 1, further comprising a check valve that prevents backflow of positive air pressure into the self-sealing suction device system when the vacuum supply is turned off.

4. The self-sealing suction device system of claim 1, wherein the solenoid valve isolates the suction device from atmospheric pressure when in a first position and vents the suction device to atmospheric pressure when in a second position.

5. The self-sealing suction device system of claim 4, wherein the controller maneuvers the solenoid valve to the second position after completion of a task.

6. The self-sealing suction device system of claim 1, wherein the self-sealing suction device system is incorporated into a robot arm.

7. The self-sealing suction device system of claim 1, wherein the self-sealing suction device system is incorporated as part of an unmanned aerial vehicle.

8. A self-sealing suction device system, comprising:
a suction device;
a pressure sensor connected to the suction device, wherein the pressure sensor is configured to detect a seal formed between the suction device and a surface that results in an increase of air pressure in the suction device above a specified threshold;
a vacuum supply connected to the suction device, wherein the vacuum supply turns on when the pressure detects the seal formed between the suction device and surface, and wherein the vacuum supply turns off when negative pressure within the self-sealing suction device system reaches a specified level; and
a solenoid valve connected to the suction device and vacuum supply, wherein the solenoid valve isolates the self-sealing suction device system from atmospheric pressure to allow the suction device to form the seal with the surface and allow the vacuum supply to generate negative pressure, and to maintain negative pressure after the vacuum supply turns off, and wherein the solenoid valve vents to atmospheric pressure to release the seal between the suction device and surface.

9. The self-sealing suction device system of claim 8, further comprising a second pressure sensor that monitors negative pressure generated by the vacuum supply.

10. The self-sealing suction device system of claim 8, further comprising a check valve that prevents backflow of positive air pressure into the self-sealing suction device system when the vacuum supply turns off.

11. The self-sealing suction device system of claim 8, wherein the solenoid valve vents to atmospheric pressure to release the seal between the suction device and surface after completion of a task.

12. The self-sealing suction device system of claim 8, wherein the self-sealing suction device system is incorporated into a robot arm.

13. The self-sealing suction device system of claim 8, wherein the self-sealing suction device system is incorporated as part of an unmanned aerial vehicle.

14. The self-sealing suction device system of claim 8, further comprising a controller programmed to control the pressure sensor, vacuum supply, and solenoid valve.

15. A method of manipulating an object with a self-sealing vacuum device system, the method comprising:
detecting, by a pressure sensor, air pressure within a suction device above a specified threshold resulting from contact between the suction device and the object;
turning on, by a controller, a vacuum supply in communication with the suction device responsive to detecting the air pressure within the suction device above the specified threshold;
turning off, by the controller, the vacuum supply responsive to detecting a specified level of negative pressure with the suction device, wherein a solenoid valve maintains the negative pressure within the suction device; and
venting, by the controller via the solenoid valve, the suction device to atmospheric pressure to release the object after completing a task.

16. The method of claim 15, wherein the solenoid valve isolates the suction device from atmospheric pressure when in a first position and vents the suction device to atmospheric pressure when in a second position.

17. The method of claim 15, further comprising monitoring, by a second pressure sensor, negative pressure flow though the self-sealing suction device system generated by the vacuum supply.

18. The method of claim 15, further comprising preventing, with a check valve, backflow of positive air pressure into the self-sealing suction device system when the vacuum supply turns off.

19. The method of claim 15, wherein the self-sealing suction device system is incorporated into a robot arm.

20. The method of claim 15, wherein the self-sealing suction device system is incorporated as part of an unmanned aerial vehicle.
